(19) United States
(12) Patent Application Publication
(10) Pub. No.: US 2024/0336745 A1
(43) Pub. Date: Oct. 10, 2024

(54) PERYLENE-BASED MICELLE CAPABLE OF RAPIDLY ADSORBING AND EFFICIENTLY DEGRADING CONTAMINANT AND METHOD FOR PREPARING SAME

(71) Applicant: SOOCHOW UNIVERSITY, Suzhou (CN)

(72) Inventors: Jianmei LU, Suzhou (CN); Hua LI, Suzhou (CN)

(21) Appl. No.: 18/293,754

(22) PCT Filed: Nov. 17, 2022
(86) PCT No.: PCT/CN2022/132565

§ 371 Date: Jan. 30, 2024

(30) Foreign Application Priority Data
Apr. 18, 2022 (CN) 202210403842.6

(51) Int. Cl. C08J 3/07; B01J 20/26; B01J 31/06; B01J 35/39; C02F 1/28; C02F 1/30; C02F 1/72; C02F 101/34; C08G 61/12

(52) U.S. Cl. CPC C08J 3/07; B01J 20/265; B01J 31/06; B01J 35/39; C02F 1/285; C02F 1/30; C02F 1/725; C08G 61/124; C02F 2101/345; C02F 2305/10; C08G 2261/126; C08G 2261/1424; C08G 2261/1426; C08G 2261/149; C08G 2261/228; C08G 2261/3241; C08G 2261/418; C08J 2365/00

(57) ABSTRACT

The present invention provides a method for synthesizing a bifunctional pure organic photocatalytic material with the capabilities of fast adsorption and efficient degradation. By means of reasonably introducing a perylene imide group into an amphiphilic block copolymer, a micelle for treating contaminants in water is formed by self-assembly. The present invention features the advantages in that the micelle formed by self-assembly of the perylene-based amphiphilic block polymer is uniform in size, exhibits ultra-high adsorption capacity on bisphenol A, and can rapidly reach a stable adsorption equilibrium at various concentrations or temperatures. The micelle also demonstrates, in a mixed phenol solution, significant recognition selectivity and good affinity for bisphenol A. In addition, the micelle has rapid degradation efficiency on bisphenol A. The present invention provides a new design concept for the advanced treatment of wastewater by using a metal-free organic material.

### TECHNICAL FIELD

The present invention belongs to the field of organic synthesis and photocatalysis technology, specifically involving the preparation of amphiphilic block copolymer materials, micellization by self-assembly and treatment of phenolic wastewater.

### BACKGROUND OF INVENTION

The continuous increase in fossil fuel consumption is a significant cause of current pollution problems, especially in the water environment closely related to the ecosystem and public health. The discharge of refractory organic compounds from cities and industries into aquatic environments is inevitable. Taking the most common polycarbonate as an example, its widespread application determines that the amount of wastewater generated in industrial production is enormous. It is noticeable that although its wastewater has a complex solution environment, including high salinity, unfavorable pH value, and low biodegradation potential, it cannot conceal the fact that there are still a wide range of high value-added substances in it, such as bisphenol A and phenol, the main components of the raw materials, which can be recovered and reused. As a new source of secondary raw materials, it is necessary to develop appropriate processes to achieve precise separation of recyclable components from wastewater. Strengthening the utilization of recycled products can compensate for the cost of industrial processing while reducing environmental stress.

When the recycling is not needed, it is necessary to thoroughly remove pollutants to avoid the threat to the ecological environment. Many physical and chemical methods directed against organic pollutants have been reported. Wherein, the adsorption is only a shallow treatment method, which is usually accompanied by a long equilibrium time, so it hinders technological progress. And the photocatalysis has long been recognized as an effective way to convert solar energy into usable chemical energy for wastewater treatment, and visible light occupies most of the solar spectrum, which is actually inexhaustible. Compared with widely studied inorganic materials, metal-free organic photocatalysts have received more attention due to their environmental friendliness and avoidance of release of toxic metals. The extendable photophysical properties and stable chemical properties make them have enormous potential in light collection and catalytic applications.

### Technical Problems

The present invention is aimed provide a synthesis method for a bifunctional pure organic photocatalytic material that integrates rapid adsorption and efficient degradation. The method provided by the present invention is to rationally introduce the perylene imide groups into amphiphilic block copolymers to form micelles by self-assembly for the treatment of pollutants in water.

### Technical Solution

In order to achieve the above objectives, the present invention adopts the following technical scheme: a perylene-based micelle that integrates rapid adsorption and efficient degradation of pollutants. The preparation method is as follows: the perylene imide monomer and hydrophilic monomer react in a solvent to obtain a perylene-based amphiphilic block polymer, which then self-assembles in a solvent to form a perylene-based micelle.

The present invention designs and synthesizes novel diblock copolymers, with perylene imide and polyethylene glycol monomers serving as the main functional groups of hydrophobic segment and hydrophilic segment respectively. The hydrophobic perylene imide monomer and hydrophilic polyethylene glycol monomer are used to obtain amphiphilic block polymers through ring opening metathesis polymerization in a solvent to design polymer materials with different ratios of hydrophilic and hydrophobic segments. The chemical structural formula of perylene-based amphiphilic block polymers is as follows:

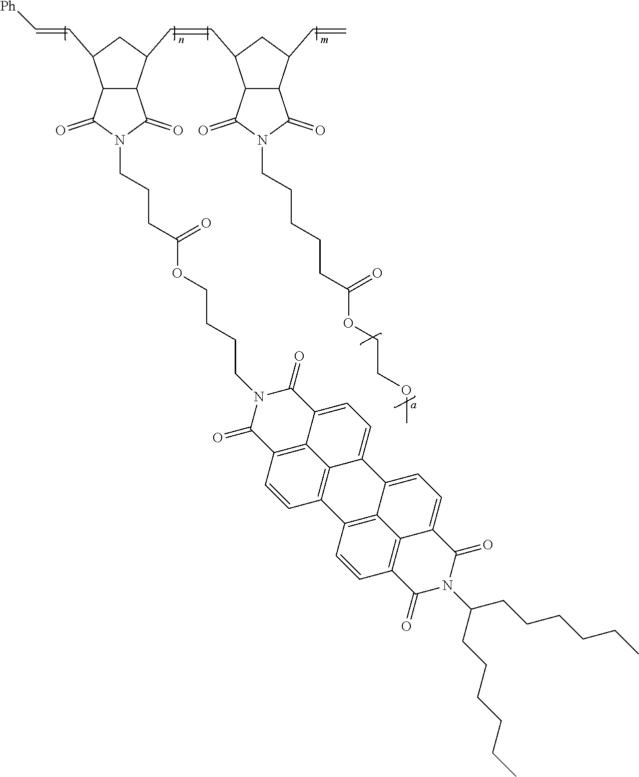

Wherein the number of repeating units n for hydrophobic segment (perylene imide segment) is 8-30, the number of repeating units m for hydrophilic segment (polyethylene glycol segment) is 5-25, and a is 10-15; The preferred values are 15-20 for n, 7-12 for m, and 10-12 for a.

In the above scheme, the perylene imide monomer is polymerized to obtain a perylene-based polymer, and then polyethylene glycol monomer is added to react to obtain a perylene-based amphiphilic block polymer. Preferably, when polymerizing perylene imide monomers, the catalyst is Grubbs third-generation catalyst and the solvent is dichloromethane; The reaction temperature is 20-35° C., the environment is an inert gas atmosphere, and the reaction time is 0.5-1.5 hours; The reaction time between perylene-based polymers and polyethylene glycol monomers is 0.5-1.5 hours. Preferably, after the reaction between perylene-based polymers and polyethylene glycol monomers is completed, the conventional purification is carried out to obtain perylene-based amphiphilic block polymers. The prepared amphiphilic block copolymer self-assembles in a solvent to prepare a micelle solution to be freeze-dried to obtain micelle powder; During the self-assembly, the solvent is tetrahydrofuran and water; The temperature for freeze-drying is −40° C., and the drying time is 24 hours.

The present invention discloses a method for removing organic pollutants from water using a perylene-based micelle that integrates rapid adsorption and efficient degradation of pollutants, and it comprises the following steps: adding a perylene-based micelle that integrates rapid adsorption and efficient degradation of pollutants to the water containing organic pollutants to complete the removal of organic pollutants from the water; Alternatively, a perylene-based micelle that integrates rapid adsorption and efficient degradation of pollutants is added to the water containing organic pollutants for lighting to complete the removal of organic pollutants from the water. The present invention achieves rapid enrichment and selective separation of pollutants through adsorption, or further utilizes lighting to achieve rapid degradation of organic pollutants. And the pollutants are phenolic pollutants.

### Beneficial Effects

The advantage of the present invention is that the size of the micelles formed by the self-assembly of perylene-based amphiphilic block polymers is uniform, and the micelles exhibit strong adsorption capacity for bisphenol A, and they quickly reach stable adsorption equilibrium under different concentrations or temperature conditions. At the same time, it exhibits significant selective recognition and good affinity for bisphenol A in the mixed phenolic solution. In addition, the micelle has high degradation efficiency for bisphenol A and exhibits good structural stability and reusability during photocatalytic processes, which has developed a new design idea for the deep treatment of wastewater using non-metallic organic materials.

### BRIEF DESCRIPTION OF THE DRAWINGS

FIG. 1 shows the synthesis diagram of perylene-based amphiphilic block polymers.

FIG. 2 shows the nuclear magnetic resonance hydrogen spectrum of the amphiphilic block copolymer PDI₁₇-PEG₉.

FIG. 3 shows the nuclear magnetic resonance hydrogen spectrum of polymer block 1.

FIG. 4 shows the transmission electron microscopy morphology of perylene-based micelle.

FIG. 5 shows the adsorption of bisphenol A by perylene-based micelles at different concentrations.

FIG. 6 shows the adsorption of bisphenol A by perylene-based micelles at different temperatures.

FIG. 7 shows the adsorption diagrams of perylene based micelles for bisphenol A and unitary phenol and mixed solution.

FIG. 8 shows the photodegradation of bisphenol A by perylene-based micelles.

FIG. 9 shows the synthesis diagram of perylene imide monomer.

FIG. 10 shows the nuclear magnetic resonance hydrogen spectrum of perylene imide monomer.

FIG. 11 shows the synthesis diagram of polyethylene glycol monomer.

FIG. 12 shows the nuclear magnetic resonance hydrogen spectrum of polyethylene glycol monomer.

FIG. 13 shows the nuclear magnetic resonance hydrogen spectrum of the amphiphilic block copolymer PDI₉-PEG₂₀.

FIG. 14 shows the adsorption of bisphenol A by perylene-based micelles at different block ratios.

### EXAMPLES OF THE PRESENT INVENTION

In order to clarify the purpose, technical solution, and advantages of the present invention, the following is a detailed explanation of each mode of execution of the present invention. However, those of ordinary skill in the art can understand that many technical details have been proposed in various Examples of the present invention to enable readers to better understand the present application. However, even without these technical details and various changes and modifications based on the following modes of execution, the technical solutions protected by the various claims of this application can still be achieved. The technical solution of the present invention is further elaborated with the accompanying drawings and specific Examples. Unless otherwise specified, the reagents, materials, instruments, etc. used in the following Examples can be obtained through commercial means; and the G3 catalyst comes from Rhawn. The specific preparation operations and experimental methods are conventional methods in this field. The testing conditions for nuclear magnetic resonance are as follows: nuclear magnetic resonance hydrogen spectrum is measured using an INOVA 400 MHz FT-NMR spectrometer at a temperature of 25° C., and all chemical shifts are based on the chemical shift values of tetramethylsilicon (TMS) protons, given in ppm.

The steps of the adsorption experiment are as follows: disperse the micelles into a certain amount of pollutant solution at different concentrations or temperatures and stir for a certain time, and the concentration changes of pollutants in the solution are characterized by liquid chromatography. The steps of the photodegradation experiment are as follows: disperse the micelles into a certain amount of pollutant solution and stir to achieve adsorption equilibrium, and the concentration changes of pollutants in the solution are analyzed under lighting and characterized by liquid chromatography. The steps of the selective adsorption experiment are as follows: disperse the micelles into a mixed solution of a certain amount of binary phenolic pollutants and stir for a certain time, and the concentration changes of each pollutant in the solution are characterized by liquid chromatography.

### Example 1: Synthesis of Perylene-Based Amphiphilic Block Copolymers

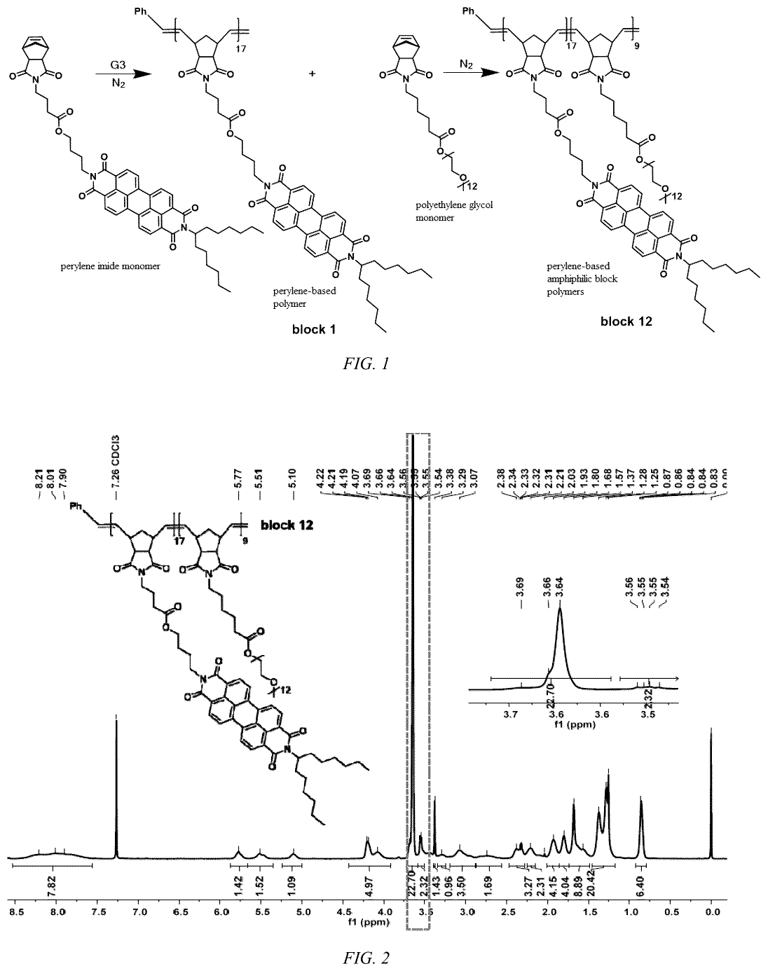

FIG. 1 shows the synthesis diagram of perylene-based amphiphilic block polymers. The perylene imide monomer was firstly polymerized to obtain a perylene-based polymer, and then polyethylene glycol monomer (hydrophilic monomer) was added to react to obtain a perylene-based amphiphilic block polymer.

G3 catalyst (12.6 mg, 0.0172 mmol) was added into a 20 mL vial, and dissolved in 2 mL of dichloromethane, then 2 mL of dichloromethane containing perylene imide monomer (300 mg, 0.343 mmol) was added, and stirred at 28° C. in a nitrogen atmosphere for 1 hour to obtain a perylene-based polymer solution; 0.2 mL of reaction solution was taken and 1 mL of ethyl vinyl ether was added to terminate the reaction as the test solution. 2 mL of dichloromethane containing PEG monomer (139.2 mg, 0.172 mmol) was added to a perylene-based polymer solution to maintain the reaction parameters for 1 hour and obtain a reddish-brown solution after the reaction was completed and 1 mL of ethyl vinyl ether was added to terminate the polymerization. Then the reaction solution was poured into 200 mL of cold ether, stirred to precipitate, and filtered to obtain a solid. Then, the solid was dissolved in 5 mL of dichloromethane, poured again into 200 mL of cold ether, stirred to precipitate, filtered to obtain the solid, and the purified to obtain pure perylene-based amphiphilic block polymer block 12, which became the red black solid (0.37 g, 60%) after drying. The nuclear magnetic resonance hydrogen spectrum shown in FIG. 2 indicates that the hydrophobic perylene imide monomer and hydrophilic polyethylene glycol monomer have successfully polymerized into an amphiphilic block copolymer, that is PDI₁₇-PEG₉.

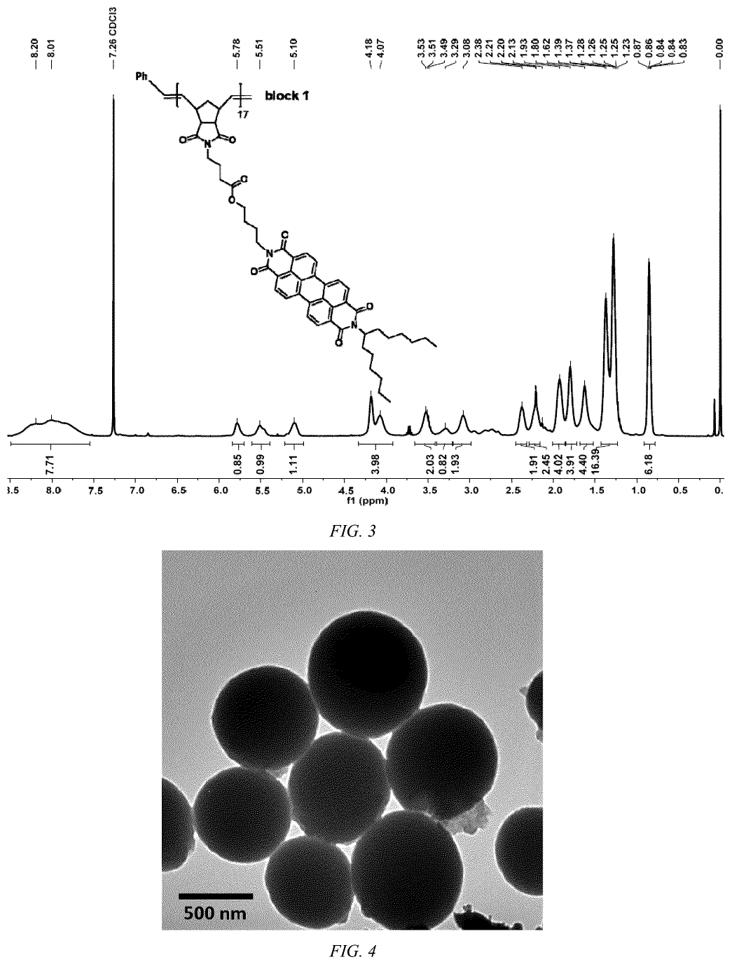

The test solution was dissolved in 1 mL of dichloromethane, poured into 40 mL of cold ether, centrifuged to obtain the perylene-based polymer block 1, and dried for standby. The nuclear magnetic resonance image of block 1 is shown in FIG. 3, indicating successful polymer synthesis.

### Example 2: Preparation of Perylene-Based Micelles

10 mg of amphiphilic block copolymer was dissolved in 2 mL of THF, 8 mL of deionized water was used as selective solvent and dropwise added according to 10×200 μL, 10×300 μL and 10×300 μL with a time interval of 15 seconds. After adding, the stirring continued for 0.5 hours to obtain a micelle solution with a concentration of 1 mg/mL. Subsequently, the micelles were freeze-dried at −40° C. for 24 hours to obtain micelle powder for further experiments. The transmission electron microscopy morphology of perylene-based micelle is shown in Figure and the micelle is spherical in size of approximately 600 nm.

### Example 3: The Adsorption Performance of Perylene-Based Micelle for Bisphenol A

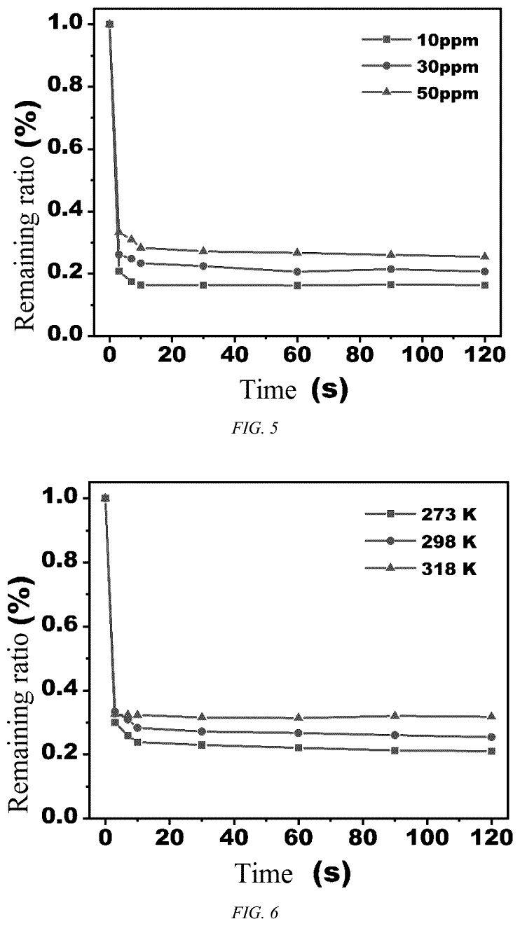

The solution volume in the adsorption experiment was 25 mL, and 10 mg of perylene-based micelles were added as adsorbent to a certain volume of deionized water (X). Before the adsorption experiment was carried out, the adsorbent solution was ultrasonically dispersed for 5 minutes. Then, the high concentration aqueous solution of bisphenol A (250 ppm, 25-X mL) was added into a small bottle and the mixed solution was stirred in a thermostatic water bath at a rate of 200 r/min for a period of time, and filtered through a filter membrane with a pore size of 0.22 microns for liquid chromatography analysis. The adsorption experiments were conducted at different final concentrations (10 ppm, 30 ppm, 50 ppm, bisphenol A, 298 K) and different temperatures (273 K, 298 K, 318 K, 50 ppm). At different concentrations (FIG. 5) and temperatures (FIG. 6), micelles could exhibit rapid adsorption rates and reached adsorption equilibrium within 10 seconds. The corresponding X values for final concentrations of 10 ppm, 30 ppm, and 50 ppm were 24 mL, 22 mL, and 20 mL, respectively.

### Example 4: The Adsorption Selectivity of Perylene-Based Micelles for Phenolic Pollutants

Phenol was used as a comparative to test the selective adsorption of bisphenol A by perylene-based micelles. The adsorption experiment was conducted in a unitary or binary mixed phenol solution. 10 mg micelles were dispersed in 20 mL of deionized water, then 5 mL of high concentration targeted pollutant (bisphenol A, phenol or binary mixture) aqueous solution was added to obtain a solution with an initial pollutant concentration of 50 mg L⁻¹ (50 ppm); The solution was stirred in a 25° C. thermostatic water bath at a rate of 200 r/min for 120 s and filtered through a filter membrane with a pore size of 0.22 m for liquid chromatography analysis of the concentration changes of pollutants. The removal rates of pollutants by micelles in different solutions are shown in FIG. 7, indicating that the micelles have strong adsorption capacity for bisphenol A and have little adsorption effect on phenol, demonstrating their adsorption selectivity for bisphenol A.

### Example 5: The Photodegradation Performance of Perylene-Based Micelle for

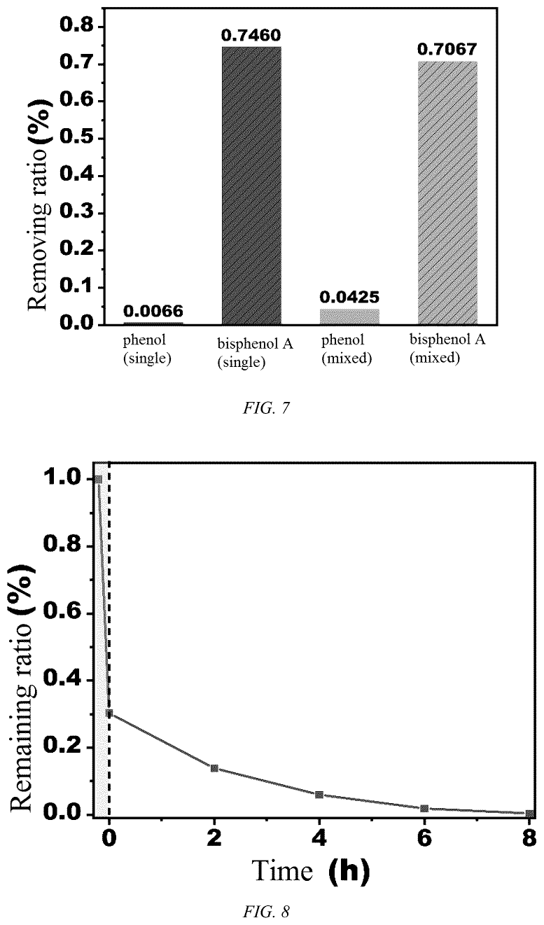

Bisphenol a 10 mg micelles were dispersed in 25 mL of 50 ppm aqueous solution of bisphenol A, and then irradiated under a 300 W xenon lamp after reaching adsorption equilibrium (>420 nm). 0.6 mL of sample was taken per hour and filtered through a filter membrane with a pore size of 0.22 m for liquid chromatography analysis of the concentration changes of pollutant solution. The photodegradation diagram of bisphenol A is shown in FIG. 8. The bisphenol A in the aqueous environment could be completely degraded within 8 hours after the micelles reached adsorption equilibrium under visible light irradiation, indicating the strong visible light catalytic performance of perylene-based micelles. In the prior art, the perylene imide fiber photocatalyst can only remove 80% of BPA (10 ppm) under the same conditions for 8 hours, while the TCNQ-PTCDI composite photocatalyst containing the same perylene unit can only remove 50% of BPA (10 ppm) after 8 hours. Therefore, the bifunctional micelle of the present invention has significant advantages compared to other perylene-based materials, and can greatly improve the removal efficiency of pollutants through adsorption concerted catalysis.

### Synthesis Example

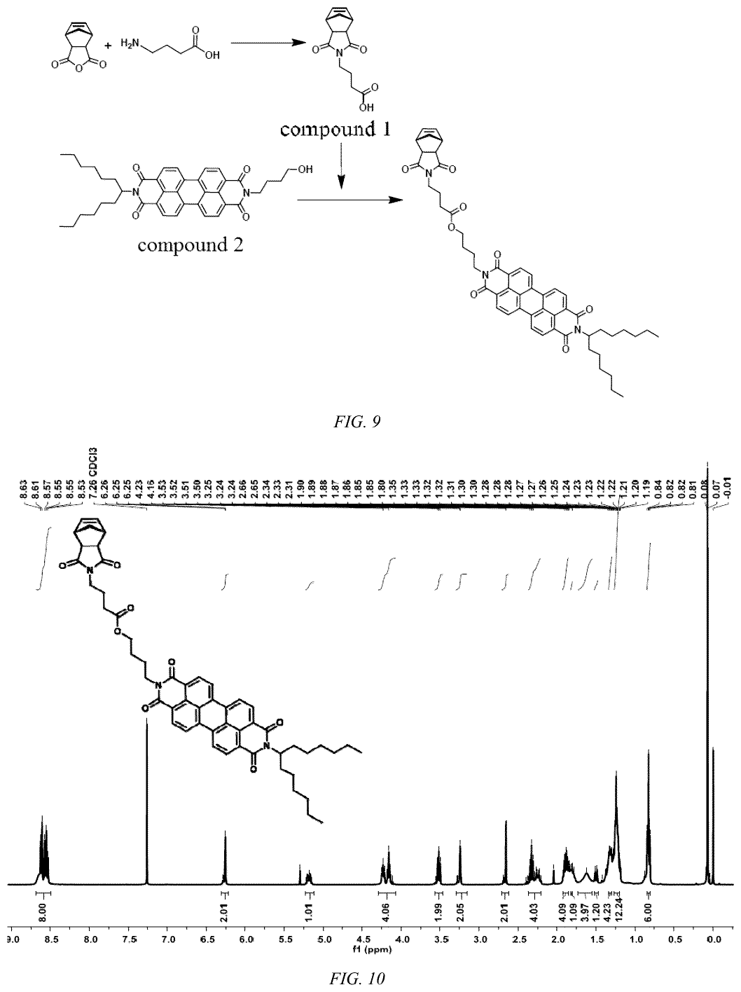

The synthesis of perylene imide monomer is shown in FIG. 9.

Added cis 5-norbornene-exo-2,3-dicarboxylic anhydride (5 g, 30.46 mmol), 4-aminobutyric acid (2.99 g, 29.01 mmol), and 250 ml of toluene were added to a 500 mL three-necked bottle equipped with an oil-water separator, respectively. The reaction was refluxed at 140° C. for 24 hours under a nitrogen atmosphere. After the reaction was completed, toluene was removed by rotary evaporation, and then 200 mL of dichloromethane was added for dissolution. Then it was sequentially washed and extracted with 1 M hydrochloric acid solution and saturated sodium chloride solution, and anhydrous sodium sulfate was added to dry the organic phase to remove residual moisture. The obtained organic phase was then rotary dried with a rotary evaporator to remove dichloromethane to obtain a light yellowish brown solid compound 1 (6.15 g, 85%).

The compound 1 (371 mg, 1.49 mmol), compound 2 (800 mg, 1.24 mmol), trimethylacetic anhydride (278 mg, 1.49 mmol), 4-dimethylaminopyridine (15 mg, 0.124 mmol), and 160 mL of tetrahydrofuran were added to a 250 ml single-necked bottle, respectively. The reaction was refluxed at 66° C. for 24 hours. After the reaction, 1 mL of deionized water was added and stirred for 1 hour. Then, it was washed with saturated sodium bicarbonate solution and saturated sodium chloride solution sequentially. Then the anhydrous sodium sulfate was added to the organic phase to remove residual moisture, and the solid was obtained by rotary evaporator. The sample was further purified by silica gel column chromatography to obtain a pure product of perylene imide monomer (956 mg, 88%). The nuclear magnetic resonance hydrogen spectrum shown in FIG. 10 confirms the successful preparation of perylene imide monomer.

The synthesis diagram of polyethylene glycol monomer is shown in FIG. 11.

Added cis 5-norbornene-exo-2,3-dicarboxylic anhydride (5 g, 30.46 mmol), 6-aminocaproic acid (3.98 g, 29.01 mmol), and 250 ml of toluene were added to a 500 mL three-necked bottle equipped with an oil-water separator, respectively. The reaction was refluxed at 140° C. for 24 hours under a nitrogen atmosphere. After the reaction was completed, toluene was rotary-dried, and then dichloromethane was added for dissolution. Then it was sequentially washed and extracted with 1 M hydrochloric acid solution and saturated sodium chloride solution. Then the anhydrous sodium sulfate was added to the organic phase to remove residual moisture. The obtained organic phase was then rotary dried with a rotary evaporator to remove dichloromethane to obtain a light yellowish brown solid compound 3 (6.98 g, 88%).

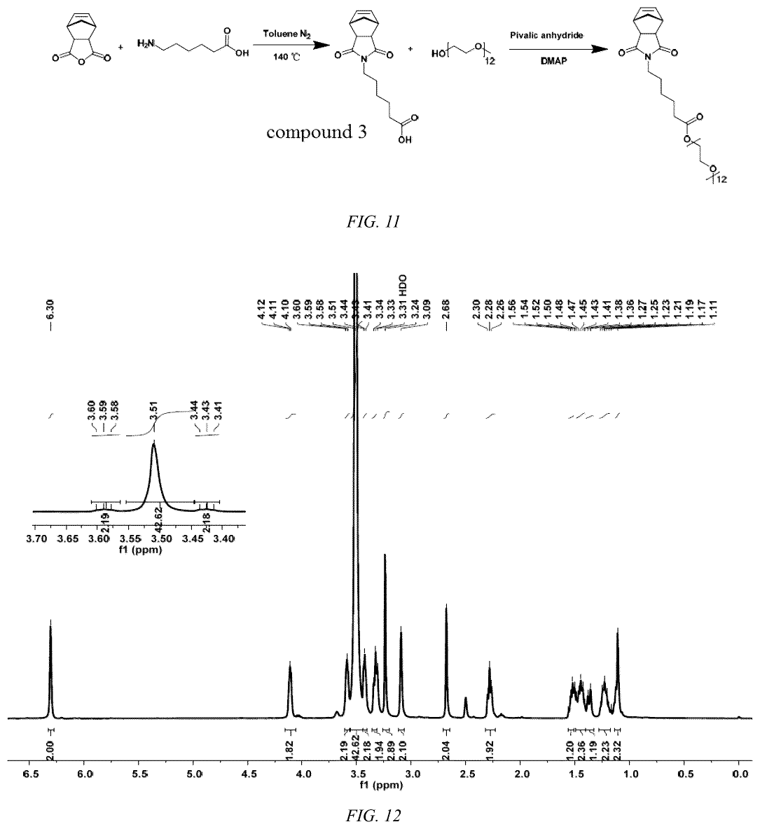

The compound 3 (3 g, 10.82 mmol), polyethylene glycol monomethyl ether 550 (4.96 g, 9.01 mmol), trimethylacetic anhydride (2.18 g, 11.72 mmol), 4-dimethylaminopyridine (0.110 g, 0.901 mmol), and 120 mL of tetrahydrofuran were added to a 250 ml single-necked bottle, respectively. It was refluxed at 66° C. for 24 hours. After the reaction, 1 mL of deionized water was added and stirred for 1 hour. Then, it was washed with saturated sodium bicarbonate solution and saturated sodium chloride solution sequentially. Then the anhydrous sodium sulfate was added to the organic phase to remove residual moisture. After filtration, the filtrate was rotary-dried with a rotary evaporator to obtain a light-yellow oily liquid. The sample was further purified by silica gel column chromatography to obtain a pure product of polyethylene glycol monomer (4.45 g, 61%). The nuclear magnetic resonance hydrogen spectrum shown in FIG. 12 confirms the successful preparation of polyethylene glycol monomer.

### Example 6

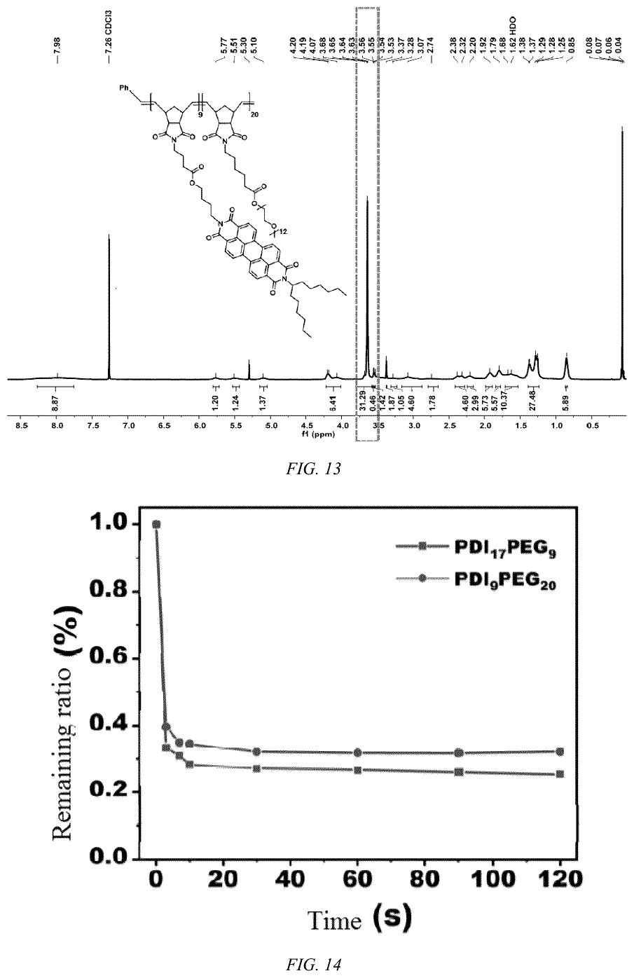

G3 catalyst (4.2 mg, 0.0057 mmol) was added into a 20 mL vial, and dissolved in 1 mL of dichloromethane, then 1 mL of dichloromethane containing perylene imide monomer (50 mg, 0.0571 mmol) was added, and stirred at 28° C. in a nitrogen atmosphere for 1 hour to obtain a perylene-based polymer solution; 1 mL of dichloromethane containing PEG monomer (92.4 mg, 0.1142 mmol) was added to a perylene-based polymer solution to maintain the reaction parameters for 1 hour and obtain a reddish brown solution after the reaction was completed and 0.5 mL of ethyl vinyl ether was added to terminate the polymerization. Then the reaction solution was poured into 100 mL of cold ether, stirred to precipitate, and filtered to obtain a solid. Then, the solid was dissolved in 2 mL of dichloromethane, poured again into 100 mL of cold ether, stirred to precipitate, filtered to obtain the solid, and the purified to obtain pure perylene-based amphiphilic block polymer PDI₉-PEG₂₀, which became the red black solid (79 mg, 55%) after drying. The nuclear magnetic resonance hydrogen spectrum is shown in FIG. 13.

PDI₉-PEG₂₀ micelles were obtained with reference to the method in the Example 2, and the adsorption of bisphenol A by micelles was tested with reference to the method in the Example 3, and the results are shown in FIG. 14 at 298K and 50 ppm.

In summary, the present invention constructs a perylene-based micelle organic photocatalytic material with visible light response. This design not only enhances the stable dispersion of the catalyst in aqueous environments, but also enhances the absorption ability of the catalyst for pollutants. The micelle has a fast adsorption rate and high adsorption capacity for specific pollutants, as well as adsorption selectivity. In terms of catalytic performance, the above-mentioned perylene-based micelle exhibits effective degradation of bisphenol A in water.

1-10. (canceled)

11. A method of preparing a perylene-based micelle, comprising:
reacting a perylene imide monomer and a hydrophilic monomer in a solvent to obtain a perylene-based amphiphilic block polymer, and
self-assembling the perylene-based amphiphilic block polymer in the solvent to form the perylene-based micelle.

12. The method according to claim 11, further comprising:
polymerizing the perylene imide monomer to obtain a perylene-based polymer, and
reacting the perylene-based polymer with a polyethylene glycol monomer to obtain the perylene-based amphiphilic block polymer.

13. The method of according to claim 12, wherein when polymerizing the perylene imide monomer, a reaction temperature is 20-35° C., a reaction condition is an inert gas atmosphere, and a reaction time is 0.5-1.5 hours.

14. The method according to claim 11, further comprising:
self-assembling the perylene-based amphiphilic block polymer in the solve to prepare a micelle solution; and
freeze-drying the micelle solution to obtain the perylene-based micelle.

15. The method according to claim 11, wherein the perylene-based micelle has the following chemical structural formula: 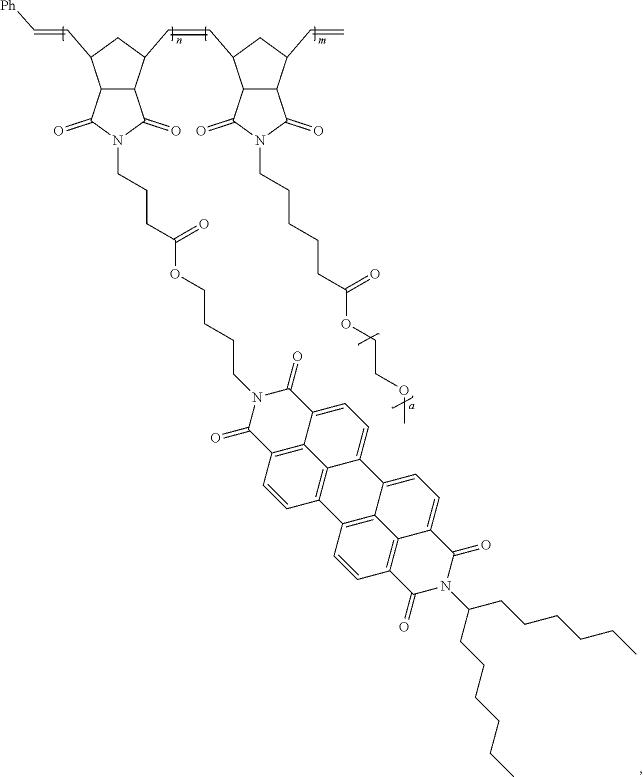
wherein n is an integer of 8-30, m is an integer of 5-25, and a is an integer of 10-15.

16. The method according to claim 15, wherein n is an integer of 15-20, and m is an integer of 7-12.

17. The method according to claim 15, wherein the perylene-based micelle integrates rapid adsorption and efficient degradation of organic pollutants.

18. The method according to claim 17, further comprising:
adding the perylene-based micelle to water containing organic pollutants; and
removing the organic pollutants from water by adsorption and degradation.

19. The method according to claim 18, wherein the organic pollutants are phenolic pollutants.

20. The method according to claim 18, further comprising:
irradiating a visible light to a mixture of the perylene-based micelle and water containing organic pollutants to remove the organic pollutants.
